(19) United States
(12) Patent Application Publication
(10) Pub. No.: US 2006/0027780 A1
(43) Pub. Date: Feb. 9, 2006

(54) Crystallization solutions

(75) Inventors: Michael David Feese, Seattle, WA (US); Aaron Hoffman, New Haven, CT (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: deCODE biostructures, Inc., Bainbridge Island, WA (US)

(21) Appl. No.: 11/171,640

(22) Filed: Jun. 30, 2005

Related U.S. Application Data
(60) Provisional application No. 60/587,231, filed on Jul. 12, 2004.

(51) Int. Cl. A23J 7/00

(52) U.S. Cl. 252/1

(57) ABSTRACT

In one aspect, the present invention provides sets of crystallization solutions that each include one of Crystallization Solution Set 1, Crystallization Solution Set 2, Crystallization Solution Set 3, and Crystallization Solution Set 4. In another aspect, the present invention provides kits that each include at least one crystallization plate and a Crystallization Solution Set of the invention.

### CROSS-REFERENCE TO RELATED APPLICATION

This application claims benefit of U.S. Provisional Patent Application No. 60/587,231, filed Jul. 12, 2004.

### FIELD OF THE INVENTION

The present invention relates to solutions that are useful for crystallizing molecules, especially macromolecules such as proteins.

### BACKGROUND OF THE INVENTION

Macromolecular X-ray crystallography is a useful tool in modern drug discovery and molecular biology. Using X-ray crystallographic techniques, the three-dimensional structures of biological macromolecules, such as proteins, nucleic acids, and their various complexes, can be determined at practically atomic-level resolution from X-ray diffraction data.

One of the first and most important steps in the X-ray crystal structure determination of a target macromolecule is to grow large, well-diffracting crystals of the macromolecule. As the techniques for collecting and analyzing X-ray diffraction data have become more rapid and automated, crystal growth has become a rate-limiting step in the structure determination process. The process of growing biological macromolecule crystals remains a highly empirical process. Macromolecular crystallization is dependent on a host of experimental parameters, including; pH, temperature, the concentration of salts in the crystallization drop, the concentration of the macromolecule to be crystallized, and the concentration of the precipitating agent (of which there are hundreds). In particular, the choice of solute conditions in which to grow crystals continues to be a matter for empirical determination. Consequently, the ability to rapidly and easily generate many crystallization trials is important in determining the ideal conditions for crystallization. Thus, there is a need for sets of preformulated crystallization solutions that can be used to rapidly and easily generate many crystallization trials.

A second crucial step is estimation of the phase angles for the structure factors, which cannot be directly measured in typical single-beam X-ray diffraction experiments. Structure factors are calculated from the measured intensities of the X-ray diffraction pattern of the crystal. The Fourier transform calculated with the measured structure factors as amplitudes and the estimated phases produces a three-dimensional image of the electron distribution that produced the diffraction pattern, allowing a model of the molecular structure to be constructed and refined. The relationship between phases and the amplitudes of structure factors is in most cases underdetermined at the resolution to which the crystal X-ray diffraction intensities, especially from macromolecular crystals, can be measured. The correct phases cannot, in general, be estimated using the measured structure factors. However, there are a number of methods by which phase information can be encoded into diffraction intensities. The most common such method is isomorphous replacement in which phase information is extracted by comparison of the difference in diffraction intensities between an unmodified (native) crystal and a crystal containing a covalently or noncovalently bound heavy atom in the ordered phase of the crystal (derivative). Another method is to collect data at a wavelength at which some of the atoms in the crystal have a strong anomalous dispersion signal. In anomalous dispersion, inelastic scattering of X-rays from inner shell electrons introduces a phase shift between Freidel pairs of reflections (Fₕₖ₁ and F₋ₕ₋ₖ₋ₗ), breaking the inherent symmetry of the diffraction pattern and encoding the phases of the anomalously scattering atoms into the differences in magnitude between Iₕₖ₁ and I₋ₕ₋ₖ₋ₗ. This anomalous dispersion signal can be used in the same way as isomorphous differences between native and derivative crystals in estimation of phases, but diffraction data from only one crystal is required.

In the last decade the use of multi-wavelength anomalous dispersion (MAD) (Hendrickson, W. A., Science 254:51-58, 1991) has become a routine method of phase determination in macromolecular crystallography. A disadvantage of the MAD method has been the requirement of tunable synchrotron radiation sources for data collection at multiple wavelengths. Recent advances in data collection techniques and phasing algorithms now allow accurate phase determination from Single-wavelength Anomalous Diffraction (SAD) experiments (Dauter, Z., et al., Acta Cryst. D58:494-506, 2002). In addition, incorporation of non-covalently bound ions into crystals of macromolecules (Dauter, Z., et al., Acta Cryst. D56:232-237, 2000; Nagem, R. A. P, et al., Acta Cryst., D57:996-1002, 2001) is applicable to a wide variety of anomalous scattering elements, many of which have strong anomalous signals at the wavelength of copper K_{α} radiation (λ=1.5418 Å) produced by laboratory X-ray generators. The availability of chromium K_{α} (λ=2.2909 Å) radiation from recently introduced chromium rotating anodes allows even stronger anomalous scattering signals to be observed from some elements with laboratory X-ray generators. Non-covalently bound anomalously scattering ions can be used for a wide variety of phasing techniques such as MAD and SAD, single isomorphous replacement with anomalous scattering (SIRAS), and multiple isomorphous replacement with anomalous scattering (MIRAS). In addition, high concentrations of anomalously scattering ions in the solution (disordered) phase of the crystal allow the application of multi-wavelength solvent contrast (MASC) techniques (Fourme, R., et al., J. Synchrotron Rad. 6:834-844, 1995) for low resolution determination of the boundary between the ordered and disordered phases of the crystal. This boundary information is useful in phase improvement by density modification techniques such as solvent flipping or solvent flattening and non-crystallographic symmetry averaging. Non-covalently bound anomalously scattering ions can also be used for standard isomorphous replacement techniques that do not take advantage of the anomalous dispersion signal.

### SUMMARY OF THE INVENTION

The present invention provides crystallization solutions that contain ions that have strong anomalous scattering signals within the wavelength range generally useful for macromolecular crystallography (0.9-2.3 Å). These ions have been shown to bind non-covalently with high occupancy to the surfaces of protein molecules in crystals, providing an excellent means for single-crystal phasing via their anomalous scattering signal.

Accordingly, the present invention provides sets of crystallization solutions useful, for example, for crystallizing molecules, such as proteins and other macromolecules. The crystallization solution sets are identified herein as Crystallization Solution Set 1, Crystallization Solution Set 2, Crystallization Solution Set 3, and Crystallization Solution Set 4. The composition of Crystallization Solution Sets 1-4 are set forth in Tables 1-4 herein.

In one aspect, the present invention provides sets of crystallization solutions that each include at least one of the following crystallization solution sets: Crystallization Solution Set 1, Crystallization Solution Set 2, Crystallization Solution Set 3, and Crystallization Solution Set 4.

In another aspect, the present invention provides kits that each include at least one crystallization plate and a set of crystallization solutions that includes at least one of the following crystallization solution sets: Crystallization Solution Set 1, Crystallization Solution Set 2, Crystallization Solution Set 3, and Crystallization Solution Set 4. In some embodiments of the kits of the invention, the crystallization solutions of the Crystallization Solution Set(s) are disposed within the reservoirs of the crystallization plate(s). The presently preferred crystallization plates for inclusion in the kits of the invention are disclosed in U.S. patent application Ser. No. 09/150,629 (now U.S. Pat. No. 6,039,804), incorporated herein by reference.

Thus, the present invention provides Crystallization Solution Sets and kits that permit a large number of crystallization conditions to be simultaneously tested in order to identify crystallization conditions under which a molecule, especially a biological macromolecule, such as a protein, can be crystallized.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a perspective view of a crystallization plate useful for inclusion in a kit of the present invention.

FIG. 2 shows a view of the upper surface of the crystallization plate shown in FIG. 1.

### DETAILED DESCRIPTION OF THE PREFERRED EMBODIMENT

In one aspect, the present invention provides sets of crystallization solutions, each crystallization solution set comprising a crystallization solution set selected from the group of crystallization solution sets consisting of Crystallization Solution Set 1, Crystallization Solution Set 2, Crystallization Solution Set 3, and Crystallization Solution Set 4. The compositions of the individual solutions that constitute Crystallization Solution Sets 1-4 are set forth in Tables 1-4. Each solution of a solution set includes polyethylene glycol (abbreviated as PEG) and a salt, referred to as an anomalous salt. The number following the abbreviation PEG (1000, 4000, 8000 or 10,000) specifies the average molecular weight of the PEG.

TABLE 1
CRYSTALLIZATION SOLUTION SET 1

| | | PEG | | Anomalous |
|---|---|---|---|---|
| Solution | PEG | Molecular | | Salt |
| No. | Concentration | Weight | Anomalous Salt | Concentration |
| 1 | 30% (w/v) | PEG 1000 | ammonium | 0.2M |
| | | | bromide | |
| 2 | 30% (w/v) | PEG 1000 | ammonium iodide | 0.2M |
| 3 | 30% (w/v) | PEG 1000 | ammonium | 0.2M |
| | | | selenate | |
| 4 | 30% (w/v) | PEG 1000 | barium acetate | 0.2M |
| 5 | 30% (w/v) | PEG 1000 | barium bromide, | 0.2M |
| | | | dihydrate | |
| 6 | 30% (w/v) | PEG 1000 | barium chloride, | 0.2M |
| | | | dihydrate | |
| 7 | 30% (w/v) | PEG 1000 | barium iodide | 0.2M |
| 8 | 30% (w/v) | PEG 1000 | cadmium acetate | 0.2M |
| 9 | 30% (w/v) | PEG 1000 | cadmium | 0.2M |
| | | | bromide, | |
| | | | tetrahydrate | |
| 10 | 30% (w/v) | PEG 1000 | cadmium iodide | 0.2M |
| 11 | 30% (w/v) | PEG 1000 | cadmium nitrate | 0.2M |
| 12 | 30% (w/v) | PEG 1000 | cadmium sulfate, | 0.2M |
| | | | hydrate | |
| 13 | 30% (w/v) | PEG 1000 | cesium acetate | 0.2M |
| 14 | 30% (w/v) | PEG 1000 | cesium bromide | 0.2M |
| 15 | 30% (w/v) | PEG 1000 | cesium chloride | 0.2M |
| 16 | 30% (w/v) | PEG 1000 | cesium fluoride | 0.2M |
| 17 | 30% (w/v) | PEG 1000 | cesium formate | 0.2M |
| 18 | 30% (w/v) | PEG 1000 | cesium iodide | 0.2M |
| 19 | 30% (w/v) | PEG 1000 | cesium nitrate | 0.2M |
| 20 | 30% (w/v) | PEG 1000 | cesium sulfate | 0.2M |
| 21 | 30% (w/v) | PEG 1000 | gadolinium | 0.2M |
| | | | acetate, hydrate | |
| 22 | 30% (w/v) | PEG 1000 | gadolinium | 0.2M |
| | | | bromide, hydrate | |
| 23 | 30% (w/v) | PEG 1000 | gadolinium | 0.2M |
| | | | chloride, hydrate | |
| 24 | 30% (w/v) | PEG 1000 | gadolinium nitrate | 0.2M |
| 25 | 30% (w/v) | PEG 1000 | holmium bromide | 0.2M |
| 26 | 30% (w/v) | PEG 1000 | holmium chloride | 0.2M |
| 27 | 30% (w/v) | PEG 1000 | holmium nitrate | 0.2M |
| 28 | 30% (w/v) | PEG 1000 | lanthanum | 0.2M |
| | | | acetate, hydrate | |
| 29 | 30% (w/v) | PEG 1000 | Lanthanum | 0.2M |
| | | | bromide | |
| 30 | 30% (w/v) | PEG 1000 | lanthanum | 0.2M |
| | | | chloride | |
| 31 | 30% (w/v) | PEG 1000 | Lanthanum nitrate | 0.2M |
| 32 | 30% (w/v) | PEG 1000 | lithium bromide | 0.2M |
| 33 | 30% (w/v) | PEG 1000 | lithium iodide | 0.2M |
| 434 | 30% (w/v) | PEG 1000 | magnesium | 0.2M |
| | | | bromide | |
| 35 | 30% (w/v) | PEG 1000 | potassium | 0.2M |
| | | | bromide | |
| 36 | 30% (w/v) | PEG 1000 | potassium iodide | 0.2M |
| 37 | 30% (w/v) | PEG 1000 | potassium | 0.2M |
| | | | selenate | |
| 38 | 30% (w/v) | PEG 1000 | samarium | 0.2M |
| | | | bromide, | |
| | | | hexahydrate | |
| 39 | 30% (w/v) | PEG 1000 | samarium | 0.2M |
| | | | chloride, | |
| | | | hexahydrate | |
| 40 | 30% (w/v) | PEG 1000 | samarium nitrate | 0.2M |
| 41 | 30% (w/v) | PEG 1000 | sodium bromide | 0.2M |
| 42 | 30% (w/v) | PEG 1000 | sodium iodide | 0.2M |
| 43 | 30% (w/v) | PEG 1000 | sodium selenate | 0.2M |
| 44 | 30% (w/v) | PEG 1000 | sodium tungstate | 0.2M |
| 45 | 30% (w/v) | PEG 1000 | Strontium nitrate | 0.2M |
| 46 | 30% (w/v) | PEG 1000 | ytterbium | 0.2M |
| | | | chloride | |
| 47 | 30% (w/v) | PEG 1000 | Yttrium nitrate | 0.2M |
| 48 | 30% (w/v) | PEG 1000 | zinc bromide | 0.2M |

TABLE 2
CRYSTALLIZATION SOLUTION SET 2

| | | PEG-4K | | Anomalous |
|---|---|---|---|---|
| Solution | PEG | Molecular | | Salt |
| No. | Concentration | Weight | Anomalous Salt | Concentration |
| 1 | 20% (w/v) | PEG 4000 | ammonium | 0.2M |
| | | | bromide | |
| 2 | 20% (w/v) | PEG 4000 | ammonium iodide | 0.2M |
| 3 | 20% (w/v) | PEG 4000 | ammonium | 0.2M |
| | | | selenate | |
| 4 | 20% (w/v) | PEG 4000 | barium acetate | 0.2M |
| 5 | 20% (w/v) | PEG 4000 | barium bromide, | 0.2M |
| | | | dihydrate | |
| 6 | 20% (w/v) | PEG 4000 | barium chloride, | 0.2M |
| | | | dihydrate | |
| 7 | 20% (w/v) | PEG 4000 | barium iodide | 0.2M |
| 8 | 20% (w/v) | PEG 4000 | cadmium acetate | 0.2M |
| 9 | 20% (w/v) | PEG 4000 | cadmium | 0.2M |
| | | | bromide, | |
| | | | tetrahydrate | |
| 10 | 20% (w/v) | PEG 4000 | cadmium iodide | 0.2M |
| 11 | 20% (w/v) | PEG 4000 | cadmium nitrate | 0.2M |
| 12 | 20% (w/v) | PEG 4000 | cadmium | 0.2M |
| | | | sulfate, hydrate | |
| 13 | 20% (w/v) | PEG 4000 | cesium acetate | 0.2M |
| 14 | 20% (w/v) | PEG 4000 | cesium bromide | 0.2M |
| 15 | 20% (w/v) | PEG 4000 | cesium chloride | 0.2M |
| 16 | 20% (w/v) | PEG 4000 | cesium fluoride | 0.2M |
| 17 | 20% (w/v) | PEG 4000 | cesium formate | 0.2M |
| 18 | 20% (w/v) | PEG 4000 | cesium iodide | 0.2M |
| 19 | 20% (w/v) | PEG 4000 | cesium nitrate | 0.2M |
| 20 | 20% (w/v) | PEG 4000 | cesium sulfate | 0.2M |
| 21 | 20% (w/v) | PEG 4000 | gadolinium | 0.2M |
| | | | acetate, hydrate | |
| 22 | 20% (w/v) | PEG 4000 | gadolinium | 0.2M |
| | | | bromide, hydrate | |
| 23 | 20% (w/v) | PEG 4000 | gadolinium | 0.2M |
| | | | chloride, hydrate | |
| 24 | 20% (w/v) | PEG 4000 | gadolinium nitrate | 0.2M |
| 25 | 20% (w/v) | PEG 4000 | holmium bromide | 0.2M |
| 26 | 20% (w/v) | PEG 4000 | holmium chloride | 0.2M |
| 27 | 20% (w/v) | PEG 4000 | holmium nitrate | 0.2M |
| 28 | 20% (w/v) | PEG 4000 | lanthanum | 0.2M |
| | | | acetate, hydrate | |
| 29 | 20% (w/v) | PEG 4000 | Lanthanum | 0.2M |
| | | | bromide | |
| 30 | 20% (w/v) | PEG 4000 | lanthanum | 0.2M |
| | | | chloride | |
| 31 | 20% (w/v) | PEG 4000 | Lanthanum nitrate | 0.2M |
| 32 | 20% (w/v) | PEG 4000 | lithium bromide | 0.2M |
| 33 | 20% (w/v) | PEG 4000 | lithium iodide | 0.2M |
| 34 | 20% (w/v) | PEG 4000 | magnesium | 0.2M |
| | | | bromide | |
| 35 | 20% (w/v) | PEG 4000 | potassium | 0.2M |
| | | | bromide | |
| 36 | 20% (w/v) | PEG 4000 | potassium iodide | 0.2M |
| 37 | 20% (w/v) | PEG 4000 | potassium | 0.2M |
| | | | selenate | |
| 38 | 20% (w/v) | PEG 4000 | samarium | 0.2M |
| | | | bromide, | |
| | | | hexahydrate | |
| 39 | 20% (w/v) | PEG 4000 | samarium | 0.2M |
| | | | chloride, | |
| | | | hexahydrate | |
| 40 | 20% (w/v) | PEG 4000 | samarium nitrate | 0.2M |
| 41 | 20% (w/v) | PEG 4000 | sodium bromide | 0.2M |
| 42 | 20% (w/v) | PEG 4000 | sodium iodide | 0.2M |
| 43 | 20% (w/v) | PEG 4000 | sodium selenate | 0.2M |
| 44 | 20% (w/v) | PEG 4000 | sodium tungstate | 0.2M |
| 45 | 20% (w/v) | PEG 4000 | Strontium nitrate | 0.2M |
| 46 | 20% (w/v) | PEG 4000 | ytterbium | 0.2M |
| | | | chloride | |
| 47 | 20% (w/v) | PEG 4000 | Yttrium nitrate | 0.2M |
| 48 | 20% (w/v) | PEG 4000 | zinc bromide | 0.2M |

TABLE 3
CRYSTALLIZATION SOLUTION SET 3

| | | PEG-8K | | Anomalous |
|---|---|---|---|---|
| Solution | PEG | Molecular | | Salt |
| No. | Concentration | Weight | Anomalous Salt | Concentration |
| 1 | 20% (w/v) | PEG 8000 | ammonium | 0.2M |
| | | | bromide | |
| 2 | 20% (w/v) | PEG 8000 | ammonium iodide | 0.2M |
| 3 | 20% (w/v) | PEG 8000 | ammonium | 0.2M |
| | | | selenate | |
| 4 | 20% (w/v) | PEG 8000 | barium acetate | |
| 5 | 20% (w/v) | PEG 8000 | barium bromide, | 0.2M |
| | | | dihydrate | |
| 6 | 20% (w/v) | PEG 8000 | barium chloride, | 0.2M |
| | | | dihydrate | |
| 7 | 20% (w/v) | PEG 8000 | barium iodide | 0.2M |
| 8 | 20% (w/v) | PEG 8000 | cadmium acetate | 0.2M |
| 9 | 20% (w/v) | PEG 8000 | cadmium | 0.2M |
| | | | bromide, | |
| | | | tetrahydrate | |
| 10 | 20% (w/v) | PEG 8000 | cadmium iodide | 0.2M |
| 11 | 20% (w/v) | PEG 8000 | cadmium nitrate | 0.2M |
| 12 | 20% (w/v) | PEG 8000 | cadmium | 0.2M |
| | | | sulfate, hydrate | |
| 13 | 20% (w/v) | PEG 8000 | cesium acetate | 0.2M |
| 14 | 20% (w/v) | PEG 8000 | cesium bromide | 0.2M |
| 15 | 20% (w/v) | PEG 8000 | cesium chloride | 0.2M |
| 16 | 20% (w/v) | PEG 8000 | cesium fluoride | 0.2M |
| 17 | 20% (w/v) | PEG 8000 | cesium formate | 0.2M |
| 18 | 20% (w/v) | PEG 8000 | cesium iodide | 0.2M |
| 19 | 20% (w/v) | PEG 8000 | cesium nitrate | 0.2M |
| 20 | 20% (w/v) | PEG 8000 | cesium sulfate | 0.2M |
| 21 | 20% (w/v) | PEG 8000 | gadolinium | 0.2M |
| | | | acetate, hydrate | |
| 22 | 20% (w/v) | PEG 8000 | gadolinium | 0.2M |
| | | | bromide, hydrate | |
| 23 | 20% (w/v) | PEG 8000 | gadolinium | 0.2M |
| | | | chloride, hydrate | |
| 24 | 20% (w/v) | PEG 8000 | gadolinium nitrate | 0.2M |
| 25 | 20% (w/v) | PEG 8000 | holmium bromide | 0.2M |
| 26 | 20% (w/v) | PEG 8000 | holmium chloride | 0.2M |
| 27 | 20% (w/v) | PEG 8000 | holmium nitrate | 0.2M |
| 28 | 20% (w/v) | PEG 8000 | lanthanum | 0.2M |
| | | | acetate, hydrate | |
| 29 | 20% (w/v) | PEG 8000 | Lanthanum | 0.2M |
| | | | bromide | |
| 30 | 20% (w/v) | PEG 8000 | lanthanum | 0.2M |
| | | | chloride | |
| 31 | 20% (w/v) | PEG 8000 | Lanthanum nitrate | 0.2M |
| 32 | 20% (w/v) | PEG 8000 | lithium bromide | 0.2M |
| 33 | 20% (w/v) | PEG 8000 | lithium iodide | 0.2M |
| 34 | 20% (w/v) | PEG 8000 | magnesium | 0.2M |
| | | | bromide | |
| 35 | 20% (w/v) | PEG 8000 | potassium | 0.2M |
| | | | bromide | |
| 36 | 20% (w/v) | PEG 8000 | potassium iodide | 0.2M |
| 37 | 20% (w/v) | PEG 8000 | potassium | 0.2M |
| | | | selenate | |
| 38 | 20% (w/v) | PEG 8000 | samarium | 0.2M |
| | | | bromide, | |
| | | | hexahydrate | |
| 39 | 20% (w/v) | PEG 8000 | samarium | 0.2M |
| | | | chloride, | |
| | | | hexahydrate | |
| 40 | 20% (w/v) | PEG 8000 | samarium nitrate | 0.2M |
| 41 | 20% (w/v) | PEG 8000 | sodium bromide | 0.2M |
| 42 | 20% (w/v) | PEG 8000 | sodium iodide | 0.2M |
| 43 | 20% (w/v) | PEG 8000 | sodium selenate | 0.2M |
| 44 | 20% (w/v) | PEG 8000 | sodium tungstate | 0.2M |
| 45 | 20% (w/v) | PEG 8000 | Strontium nitrate | 0.2M |
| 46 | 20% (w/v) | PEG 8000 | ytterbium | 0.2M |
| | | | chloride | |
| 47 | 20% (w/v) | PEG 8000 | Yttrium nitrate | 0.2M |
| 48 | 20% (w/v) | PEG 8000 | zinc bromide | 0.2M |

TABLE 4
CRYSTALLIZATION SOLUTION SET 4

| | | PEG-10K | | Anomalous |
|---|---|---|---|---|
| Solution | PEG | Molecular | | Salt |
| No. | Concentration | Weight | Anomalous Salt | Concentration |
| 1 | 10% (w/v) | PEG | ammonium | 0.2M |
| | | 10,000 | bromide | |
| 2 | 10% (w/v) | PEG | ammonium iodide | 0.2M |
| | | 10,000 | | |
| 3 | 10% (w/v) | PEG | ammonium | 0.2M |
| | | 10,000 | selenate | |
| 4 | 10% (w/v) | PEG | barium acetate | 0.2M |
| | | 10,000 | | |
| 5 | 10% (w/v) | PEG | barium bromide, | 0.2M |
| | | 10,000 | dihydrate | |
| 6 | 10% (w/v) | PEG | barium chloride, | 0.2M |
| | | 10,000 | dihydrate | |
| 7 | 10% (w/v) | PEG | barium iodide | 0.2M |
| | | 10,000 | | |
| 8 | 10% (w/v) | PEG | cadmium acetate | 0.2M |
| | | 10,000 | | |
| 9 | 10% (w/v) | PEG | cadmium | 0.2M |
| | | 10,000 | bromide, | |
| | | | tetrahydrate | |
| 10 | 10% (w/v) | PEG | cadmium iodide | 0.2M |
| | | 10,000 | | |
| 11 | 10% (w/v) | PEG | cadmium nitrate | 0.2M |
| | | 10,000 | | |
| 12 | 10% (w/v) | PEG | cadmium sulfate, | 0.2M |
| | | 10,000 | hydrate | |
| 13 | 10% (w/v) | PEG | cesium acetate | 0.2M |
| | | 10,000 | | |
| 14 | 10% (w/v) | PEG | cesium bromide | 0.2M |
| | | 10,000 | | |
| 15 | 10% (w/v) | PEG | cesium chloride | 0.2M |
| | | 10,000 | | |
| 16 | 10% (w/v) | PEG | cesium fluoride | 0.2M |
| | | 10,000 | | |
| 17 | 10% (w/v) | PEG | cesium formate | 0.2M |
| | | 10,000 | | |
| 18 | 10% (w/v) | PEG | cesium iodide | 0.2M |
| | | 10,000 | | |
| 19 | 10% (w/v) | PEG | cesium nitrate | 0.2M |
| | | 10,000 | | |
| 20 | 10% (w/v) | PEG | cesium sulfate | 0.2M |
| | | 10,000 | | |
| 21 | 10% (w/v) | PEG | gadolinium | 0.2M |
| | | 10,000 | acetate, hydrate | |
| 22 | 10% (w/v) | PEG | gadolinium | 0.2M |
| | | 10,000 | bromide, hydrate | |
| 23 | 10% (w/v) | PEG | gadolinium | 0.2M |
| | | 10,000 | chloride, hydrate | |
| 24 | 10% (w/v) | PEG | gadolinium nitrate | 0.2M |
| | | 10,000 | | |
| 25 | 10% (w/v) | PEG | holmium bromide | 0.2M |
| | | 10,000 | | |
| 26 | 10% (w/v) | PEG | holmium chloride | 0.2M |
| | | 10,000 | | |
| 27 | 10% (w/v) | PEG | holmium nitrate | 0.2M |
| | | 10,000 | | |
| 28 | 10% (w/v) | PEG | lanthanum | 0.2M |
| | | 10,000 | acetate, hydrate | |
| 29 | 10% (w/v) | PEG | Lanthanum | 0.2M |
| | | 10,000 | bromide | |
| 30 | 10% (w/v) | PEG | lanthanum | 0.2M |
| | | 10,000 | chloride | |
| 31 | 10% (w/v) | PEG | Lanthanum nitrate | 0.2M |
| | | 10,000 | | |
| 32 | 10% (w/v) | PEG | lithium bromide | 0.2M |
| | | 10,000 | | |
| 33 | 10% (w/v) | PEG | lithium iodide | 0.2M |
| | | 10,000 | | |
| 34 | 10% (w/v) | PEG | magnesium | 0.2M |
| | | 10,000 | bromide | |
| 35 | 10% (w/v) | PEG | potassium | 0.2M |
| | | 10,000 | bromide | |
| 36 | 10% (w/v) | PEG | potassium iodide | 0.2M |
| | | 10,000 | | |
| 37 | 10% (w/v) | PEG | potassium | 0.2M |
| | | 10,000 | selenate | |
| 38 | 10% (w/v) | PEG | samarium | 0.2M |
| | | 10,000 | bromide, | |
| | | | hexahydrate | |
| 39 | 10% (w/v) | PEG | samarium | 0.2M |
| | | 10,000 | chloride, | |
| | | | hexahydrate | |
| 40 | 10% (w/v) | PEG | samarium nitrate | 0.2M |
| | | 10,000 | | |
| 41 | 10% (w/v) | PEG | sodium bromide | 0.2M |
| | | 10,000 | | |
| 42 | 10% (w/v) | PEG | sodium iodide | 0.2M |
| | | 10,000 | | |
| 43 | 10% (w/v) | PEG | sodium selenate | 0.2M |
| | | 10,000 | | |
| 44 | 10% (w/v) | PEG | sodium tungstate | 0.2M |
| | | 10,000 | | |
| 45 | 10% (w/v) | PEG | Strontium nitrate | 0.2M |
| | | 10,000 | | |
| 46 | 10% (w/v) | PEG | ytterbium | 0.2M |
| | | 10,000 | chloride | |
| 47 | 10% (w/v) | PEG | Yttrium nitrate | 0.2M |
| | | 10,000 | | |
| 48 | 10% (w/v) | PEG | zinc bromide | 0.2M |
| | | 10,000 | | |

All of the crystallization solutions are made with ultrapure ASTM Type I water, and sterile-filtered into sterile tubes. The sterile crystallization solutions should be stored at room temperature

When using the crystallization solutions of the present invention to crystallize a molecule, the molecule should preferably be as highly purified as possible. If the molecule to be crystallized is a protein, preferably the protein should appear greater than 97% pure as determined by silver-stained SDS-PAGE. When the molecular sample is a biological macromolecule, such as a protein, the molecular sample should preferably be dissolved in as minimal a buffer as possible (i.e., the buffer should preferably contain as few chemical components as possible) to help maintain the biological activity of the macromolecule. An exemplary range for the concentration of the molecular sample is in the range of 5 mg/ml to 15 mg/ml.

The crystallization solution sets of the present invention can be used in any crystallization technique, such as vapor diffusion techniques as described, for example, in Gilliland, G. L., and D. R. Davies, Methods in Enzymol. 104:370-381, 1984; McPherson, A., Eur. J. Biochem. 189:1-23, 1990; and Weber, P. C., Adv. in Prot. Chem. 41:1-36, 1991. For example, hanging drop crystallization is a vapor diffusion technique that typically utilizes crystallization plates including a plurality of reservoirs, such as those available from Hampton Research (27632 El Lazo Rd., Laguna Niguel, Calif. 92677) and ICN-Flow (3300 Hyland Ave., Costa Mesa, Calif. 92626). In an exemplary hanging drop crystallization experiment, sealant, such as petroleum jelly or vacuum grease, is applied to the rim of a crystallization plate reservoir and 0.5-1.0 ml of a single crystallization solution of the present invention is pipetted into the reservoir. 1-10 μl (depending on availability) of the macromolecule sample is pipetted onto a siliconized cover slip (plates from Hampton Research and ICN-Flow typically require 22 mm square or round cover slips) and an equal volume of the crystallization solution that is in the reservoir is added to the sample drop on the cover slip and mixed by repeatedly aspirating and dispensing the solution from the pipettor. The cover slip is inverted and sealed over the reservoir. When a crystallization solution set of the present invention is utilized, this sequence of events can be repeated for all of the crystallization solutions in the crystallization solution set.

Similarly, sitting drop crystallization is a type of vapor diffusion technique that utilizes sitting drop crystallization plates, including a plurality of reservoirs within each of which is located a pedestal that includes a sample depression within its upper end, such as those available from Charles Supper Co. (15 Tech Circle, Natick, Mass. 01760). In an exemplary sitting drop crystallization experiment utilizing the crystallization solutions of the present invention, 0.5-1.0 ml of a single crystallization solution are pipetted into a reservoir of a sitting drop crystallization plate and 1-10 μl of the sample are pipetted into the sample depression of the sitting drop pedestal. An equal volume of the crystallization solution that is in the reservoir is added to the sample drop and mixed. This procedure can be repeated, utilizing a different crystallization solution in each of the reservoirs. The reservoirs can be individually sealed with sealant and cover slips, or the entire sitting drop plate can be sealed with a single piece of clear sealing tape after application of sample to all wells has been completed.

By way of non-limiting example, other crystallization techniques that can utilize the crystallization solution sets of the present invention include sandwich drop vapor diffusion which is similar to hanging drop and sitting drop vapor diffusion, except that the crystallization drop is contacted on two sides by glass or plastic surfaces. See, e.g., McPherson, A., Eur. J. Biochem. 189:1-23, 1990. Sandwich drop crystallization plates are available from Hampton Research and ICN-Flow. In the technique of crystallization using oils, the rate of equilibration by vapor diffusion can be modulated by placing a layer of oil between the crystallization drop and the reservoir (see, e.g., Chayen, N. E., J. Appl. Cryst. 30:198-202, 1997). Alternatively, oils can be used to seal microbatch crystallization drops, in the absence of a larger reservoir of crystallization solution (see, e.g., Chayen, N. E., et al., J. Appl. Cryst. 23:297-302, 1990). In the technique of capillary crystallization, layers of sample solution and crystallization solution can be deposited in a capillary 0.5-1.0 mm in diameter, either with an air space between the solutions or with a direct liquid-liquid interface. Crystallization occurs by vapor diffusion or liquid-liquid diffusion inside the capillary.

If the supply of sample permits, it is preferable to set up the crystallizations in duplicate, with one set of crystallizations placed at room temperature (typically from about 16° C. to about 25° C.), and the other one at 4° C. Regardless of the crystallization method used, the crystallization trials should preferably be stored in a place free of vibrations or mechanical shock, which could result in premature precipitation.

Typically, observations of crystallization trials are recorded every one or two days. The crystallization trials can be viewed under a stereo microscope at 10-100 times magnification. If less than ten percent of the samples in the crystallization screen do not show heavy precipitate after one day, it may be desirable to increase the concentration of the sample molecule. If more than fifty percent of the samples in the crystallization screen show heavy precipitate after one day, it may be desirable to reduce the sample molecule concentration.

Crystals suitable for X-ray data collection are generally 0.1 mm or greater in their smallest dimension, and have clean, sharp edges. Viewing the crystallization trials between crossed polarizers often aids in distinguishing microcrystals from amorphous precipitate. Except for the rather unusual occurrence of a cubic space group, X-ray diffraction quality biological macromolecule crystals are birefringent (have more than one refractive index), and turn polarized light. When rotated between crossed polarizers, the intensity and/or color of light transmitted through birefringent crystals will change, with a periodicity of 90 degrees. Amorphous precipitates will not transmit and turn polarized light.

In another aspect, the present invention provides kits comprising at least one crystallization plate and a set of crystallization solutions comprising a set of crystallization solutions selected from the group of sets of crystallization solutions consisting of Crystallization Solution Set 1, Crystallization Solution Set 2, Crystallization Solution Set 3, and Crystallization Solution Set 4. In some embodiments, the Crystallization Solution Sets are disposed with the reservoirs of the crystallization plate(s) which can therefore be immediately used to conduct crystallization experiments.

Any crystallization plate can be included in the kits of the present invention, including, by way of non-limiting example: Hampton Research plate models VDX, Linbro, Costar, Cryschem, Q-Plate, Q-Plate II and Crystal Clear Strips; Charles Supper Co. sitting drop plates and ICN Linbro model. The presently preferred crystallization plates are disclosed in U.S. Pat. No. 6,039,804, incorporated herein by reference.

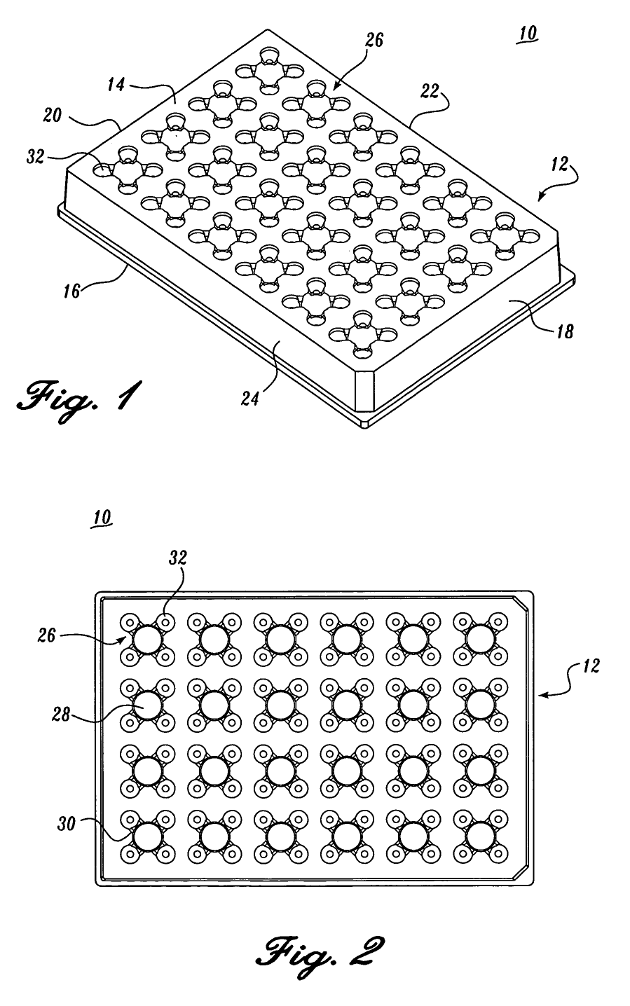

FIG. 1 shows a perspective view of a crystallization plate useful for inclusion in a kit of the present invention. FIG. 2 shows a view of the upper surface of the crystallization plate shown in FIG. 1. Crystallization plate 10 includes a body 12 having an upper surface 14, a lower surface 16, a first end 18, a second end 20, a first side 22 and a second side 24. Body 12 defines a plurality of crystallization units 26. As shown more clearly in FIG. 2, each crystallization unit 26 includes a central reservoir 28, four diffusion channels 30 and four drop chambers 32. Each drop chamber 32 is connected to central reservoir 28 by one diffusion channel 30. Each central reservoir 28 can contain a crystallization solution (typically a different crystallization solution from any other central reservoir 28 in plate 10). Thus, a kit of the present invention can be used to test the ability of numerous crystallization solutions to cause a selected protein (or other molecule) to crystallize.

A kit of the present invention may optionally include, for example, water-permeable silicone oil DC200 (BDH, Gallard Schlesinger Industries, 584 Mineola Ave., Carle Place, N.Y. 11514-1744, catalogue number 63002 4N), and/or paraffin oil (Fluka Chemical Corp., 980 South 2nd St., Ronkonkoma, N.Y. 11779-7238, catalogue number 76235) which are useful in microbatch crystallizations, and vapor diffusion crystallizations with oils.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A set of crystallization solutions comprising one of Crystallization Solution Set 1, Crystallization Solution Set 2, Crystallization Solution Set 3, and Crystallization Solution Set 4.

2. A set of crystallization solutions of claim 1 comprising Crystallization Solution Set 1.

3. A set of crystallization solutions of claim 2 consisting of Crystallization Solution Set 1.

4. A set of crystallization solutions of claim 1 comprising Crystallization Solution Set 2.

5. A set of crystallization solutions of claim 4 consisting of Crystallization Solution Set 2.

6. A set of crystallization solutions of claim 1 comprising Crystallization Solution Set 3.

7. A set of crystallization solutions of claim 6 consisting of Crystallization Solution Set 3.

8. A set of crystallization solutions of claim 1 comprising Crystallization Solution Set 4.

9. A set of crystallization solutions of claim 8 consisting of Crystallization Solution Set 4.

10. A kit comprising a crystallization plate and a set of crystallization solutions comprising one of Crystallization Solution Set 1, Crystallization Solution Set 2, Crystallization Solution Set 3, and Crystallization Solution Set 4.

11. A kit of claim 10 wherein the set of crystallization solutions comprises Crystallization Solution Set 1.

12. A kit of claim 10 wherein the set of crystallization solutions comprises Crystallization Solution Set 2.

13. A kit of claim 10 wherein the set of crystallization solutions comprises Crystallization Solution Set 3.

14. A kit of claim 10 wherein the set of crystallization solutions comprises Crystallization Solution Set 4.

15. A kit of claim 10 wherein the set of crystallization solutions consists of Crystallization Solution Set 1.

16. A kit of claim 10 wherein the set of crystallization solutions consists of Crystallization Solution Set 2.

17. A kit of claim 10 wherein the set of crystallization solutions consists of Crystallization Solution Set 3.

18. A kit of claim 10 wherein the set of crystallization solutions consists of Crystallization Solution Set 4.

19. A kit of claim 10 wherein the set of crystallization solutions consists of a multiplicity of different crystallization solutions, the crystallization plate comprises a multiplicity of wells, and each well contains a different one of the multiplicity of crystallization solutions.
